(19) United States
(12) Patent Application Publication
(10) Pub. No.: US 2024/0273495 A1
(43) Pub. Date: Aug. 15, 2024

(54) COMPUTER-READABLE RECORDING MEDIUM, SYSTEM AND CONTROL METHOD

(71) Applicant: SQUARE ENIX CO., LTD., Tokyo (JP)

(72) Inventors: Naoyuki TAMATE, Tokyo (JP); Yosuke TOYODA, Tokyo (JP); Fumiya IWAHASHI, Tokyo (JP)

(73) Assignee: SQUARE ENIX CO., LTD., Tokyo (JP)

(21) Appl. No.: 18/438,206

(22) Filed: Feb. 9, 2024

(30) Foreign Application Priority Data
Feb. 10, 2023 (JP) 2023-019354

(51) Int. Cl. G06Q 20/12; A63F 13/79; G06F 21/10

(52) U.S. Cl. CPC G06Q 20/123; A63F 13/79; G06F 21/108; A63F 2300/575

(57) ABSTRACT

According to one or more embodiments, a system that enables a user to easily perceive states of off-chain and on-chain content is provided. Content managed on-chain and content managed off-chain are displayed on one screen. The system includes a terminal apparatus and a server apparatus capable of communicating with a distributed ledger network and provides a service including content. The ownership of the content is recordable in the distributed ledger network. The content is stored in a storage device of the server apparatus or recorded on a distributed ledger in the distributed ledger network. The system acquires information about the stored content, acquires information about the recorded content, and displays on-chain information and off-chain information of the content designated from a user on a content moving screen on the terminal apparatus.

### CROSS-REFERENCE TO RELATED APPLICATION(S)

The present disclosure claims priority to Japanese Patent Application No. 2023-019354, filed on Feb. 10, 2023, the disclosure of which is expressly incorporated herein by reference in its entirety for any purpose.

### BACKGROUND

The present disclosure relates to a computer-readable recording medium, a system, and a control method.

In recent years, a service using distributed ledger technology (DLT) or blockchain technology has been provided (for example, refer to “CRYPTO SPELLS”, [online], CryptoGames Inc., [searched on Nov. 29, 2022], Internet <URL: https://cryptospells.jp/>). In the service, a user owns content such as a character or an item as a non fungible token (NTF).

NFTs can be bought and sold in transactions at a predetermined market such as a marketplace, and a transaction history of the NFT is written on a ledger included in a blockchain network (hereinafter, referred to as a distributed ledger network).

### SUMMARY

The content to be used in the service includes off-chain content managed in a server apparatus and on-chain content managed in the distributed ledger network. In the case of using the content in the service, the content often has to be in a state (so-called off-chain) managed in the server apparatus. In addition, in the case of transferring the content to another person, the content often has to be in a state (so-called on-chain) managed in the distributed ledger network.

In using the service, it has been difficult for the user to perceive how many pieces of the off-chain content are present or how many pieces of the on-chain content are present.

According to a non-limiting aspect, the present disclosure is to provide a non-transitory computer-readable recording medium having recorded thereon a program executed in a server apparatus in a system that includes a terminal apparatus and the server apparatus connected to the terminal apparatus through a communication network and that provides a service including one or more pieces of content, the terminal apparatus and/or the server apparatus being capable of communicating with a distributed ledger network, ownership of the content being recordable in the distributed ledger network, and the content being stored in a storage device of the server apparatus or being recorded on a distributed ledger included in the distributed ledger network, the program causing the server apparatus to perform functions comprising: acquiring information about the content recorded in the distributed ledger network, acquiring information about the content stored in the server apparatus, and outputting information for displaying on-chain information and off-chain information of content designated from a user (hereinafter, referred to as designated content) on one content moving screen.

According to a non-limiting aspect, the present disclosure is to provide a system that includes a terminal apparatus and a server apparatus connected to the terminal apparatus through a communication network and that provides a service including one or more pieces of content, the terminal apparatus and/or the server apparatus being capable of communicating with a distributed ledger network, ownership of the content being recordable in the distributed ledger network, and the content being stored in a storage device of the server apparatus or being recorded on a distributed ledger included in the distributed ledger network, the system comprising: acquiring information about the content recorded in the distributed ledger network, acquiring information about the content stored in the server apparatus, and displaying on-chain information and off-chain information of content designated from a user (hereinafter, referred to as designated content) on one content moving screen on the terminal apparatus.

According to a non-limiting aspect, the present disclosure is to provide a control method executed in a system that includes a terminal apparatus and a server apparatus connected to the terminal apparatus through a communication network and that provides a service including one or more pieces of content, the terminal apparatus and/or the server apparatus being capable of communicating with a distributed ledger network, ownership of the content being recordable in the distributed ledger network, and the content being stored in a storage device of the server apparatus or being recorded on a distributed ledger included in the distributed ledger network, the control method comprising: acquiring information about the content recorded in the distributed ledger network, acquiring information about the content stored in the server apparatus, and displaying on-chain information and off-chain information of content designated from a user (hereinafter, referred to as designated content) on one content moving screen on the terminal apparatus.

Each embodiment of the present disclosure addresses one or more deficiencies.

### BRIEF DESCRIPTION OF THE DRAWINGS

FIG. 1 is a block diagram illustrating a configuration of a system according to at least one embodiment of the present disclosure.

FIG. 2 is a block diagram illustrating a configuration of a server apparatus according to at least one embodiment of the present disclosure.

FIG. 3 is a flowchart of program execution processing according to at least one embodiment of the present disclosure.

FIG. 4 is a block diagram illustrating a configuration of the server apparatus according to at least one embodiment of the present disclosure.

FIG. 5 is a flowchart of the program execution processing according to at least one embodiment of the present disclosure.

FIGS. 6A and 6B are diagrams for illustrating selection of content and a content moving screen according to at least one embodiment of the disclosure.

### DESCRIPTION OF EMBODIMENTS

Hereinafter, examples of embodiments of the present disclosure will be described with reference to the accompanying drawings. Description related to an effect below is one aspect of an effect of the embodiments of the present disclosure, and the present disclosure is not limited to the description. In addition, contents described as an example of an embodiment may not be described in another embodiment. Furthermore, contents of operations and processing not related to a characteristic part of each embodiment may not be described. An order of each processing constituting a flowchart illustrated below may be changed without contradiction or inconsistency in processing contents.

### First Embodiment

A summary of a first embodiment of the present disclosure will be described. Hereinafter, a system that includes a terminal apparatus and a server apparatus connected to the terminal apparatus through a communication network and that provides a service including one or more pieces of content will be illustratively described as the first embodiment.

### Summary of System

In the first embodiment of the present disclosure, a game will be described as an example of the service. In addition, digital content that can be used in the game will be described as an example of the content. More specifically, an NFT art, a character, an enemy object, an object that can be disposed in a space in the game, an item that can be used by the character, and the like will be described.

The content may include content for which an NFT corresponding to the content can be issued and content for which the NFT cannot be issued. While the content described below is limited to the content for which the NFT can be issued, the content for which the NFT cannot be issued may be included.

### System

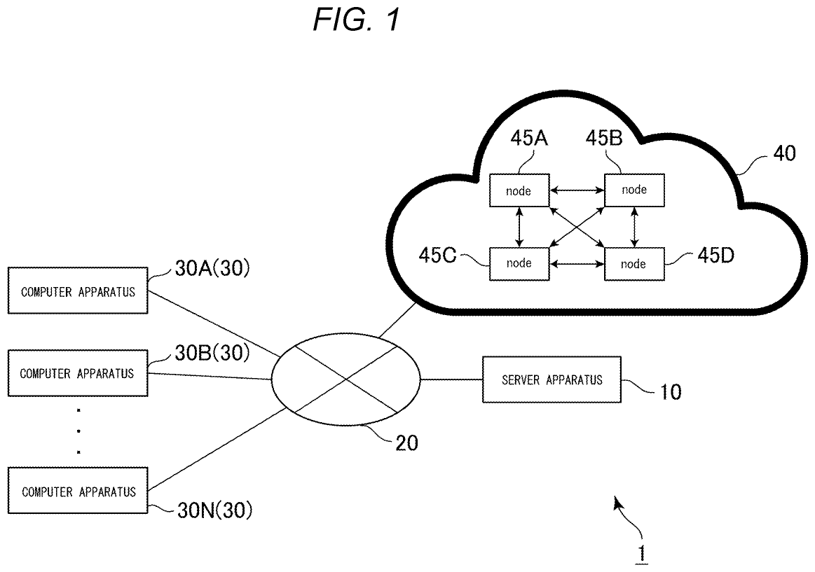

FIG. 1 is a block diagram illustrating a configuration of the system according to at least one embodiment of the present disclosure. As illustrated in FIG. 1, a system 1 includes a server apparatus 10, a communication network 20, a client terminal apparatus 30 (30A, 30B, . . . , 30N; N is a natural number) used by each of a plurality of users (players) who play a video game (game), and a distributed ledger network 40 connected to be capable of sharing contents of a distributed ledger.

It is assumed that the user has an account (wallet) that enable the user to connect to the distributed ledger network. Furthermore, it is preferable that the user can connect to the distributed ledger network 40 from the server apparatus 10 by providing, in advance, the server apparatus 10 with information (for example, an identification number or a password) that enables the server apparatus 10 to connect to the wallet.

The server apparatus 10 and/or the terminal apparatus 30 may be capable of communicating with the distributed ledger network. Ownership of the content can be recorded in the distributed ledger network 40. The content may be stored in a storage device of the server apparatus 10 or be recorded on the distributed ledger included in the distributed ledger network 40.

The system 1 may be configured with a plurality of service providers. That is, a company that manages the server apparatus 10 may be different from a company that manages the distributed ledger network 40.

### Server Apparatus

The server apparatus 10, for example, includes at least a control part, a RAM, a storage part (storage device), and a communication interface that are connected to each other through an internal bus. The control part may include an internal timer. In addition, the server apparatus 10 may synchronize with an external server through a communication interface. Accordingly, the real time may be acquired.

The server apparatus 10 may be a game processing server that controls progress of the game. In this case, the server apparatus 10 controls the progress of the game in accordance with an operation of the player. The server apparatus 10 may provide the user with various electronic services not limited to the game.

### Communication Network

The communication network 20 may be, for example, the Internet or a LAN and may enable communication between connected apparatuses.

### Terminal Apparatus

The terminal apparatus 30 includes, for example, a control part, a RAM, a storage part, a sound processing part, a graphics processing part, a communication interface, and an interface part that are connected to each other through an internal bus. The graphics processing part is connected to a display part. The display part may include a display screen and a touch input part that receives input based on a contact of the user with the display part.

The touch input part may be able to detect a position of the contact using any method of, for example, a resistive film method, an electrostatic capacitive method, an ultrasonic surface acoustic wave method, an optical method, or an electromagnetic induction method used in a touch panel. Any of the methods may be used as long as an operation can be recognized by a touch operation of the user. The touch input part is a device that can detect a position of a finger or the like in a case where an operation such as a press or a movement is performed on an upper surface of the touch input part with a finger, a stylus, or the like.

An external memory (for example, an SD card) may be connected to the interface part. Data read from the external memory is loaded into the RAM, and calculation processing is executed by the control part.

The communication interface can be connected to the communication network in a wireless or wired manner and can receive data through the communication network. In the same manner as the data read from the external memory, the data received through the communication interface is loaded into the RAM, and the calculation processing is performed by the control part.

The terminal apparatus 30 may include a sensor such as a proximity sensor, an infrared sensor, a gyro sensor, or an acceleration sensor. In addition, the terminal apparatus 30 may include an imaging part that includes a lens and that performs imaging through the lens. Furthermore, the terminal apparatus 30 may be a terminal apparatus that can be mounted (wearable) on a human body.

### Distributed Ledger Network

The distributed ledger network 40 may include a plurality of nodes 45 such as computer apparatuses in which the distributed ledger is stored in a storage device. While nodes 45A to 45D are illustrated in FIG. 1 as an example, the number of nodes is not limited to four.

In the distributed ledger network 40, data in units called blocks is generated and is connected like a chain to form a blockchain. Information can be securely maintained by storing the same distributed ledger in each node. The server apparatus 10 and/or the terminal apparatus 30 may be connected to be capable of communicating with the distributed ledger network 40. The server apparatus 10 and/or the terminal apparatus 30 may function as nodes included in the distributed ledger network 40.

In the distributed ledger network 40, transactions of tokens can be made. As the distributed ledger network 40, an existing platform such as Ethereum may be employed. The distributed ledger network 40 may also have a function of a marketplace at which NFTs can be issued (generated or minted), bought, and sold in transactions. This blockchain technology is a general configuration and thus, will not be described in detail.

### Content

As described above, the content is digital content and is a creation such as an object or an item that can be used in the service. The ownership of the content can be recorded on the distributed ledger by converting the content into an NFT. The user can make a purchase (primary distribution) at a market such as a marketplace at which digital content can be bought and sold using, for example, legal currency or virtual currency. The user can exhibit the content owned by the user at the marketplace or the like for sale and can transfer the content to another user (secondary distribution).

### Description of Functions

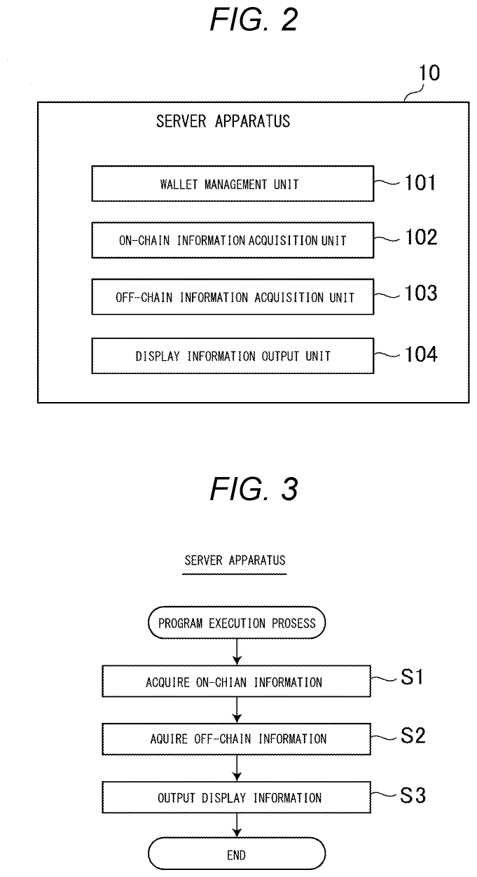

Functions of the server apparatus 10 in the first embodiment will be described. FIG. 2 is a block diagram illustrating a configuration of the server apparatus according to at least one embodiment of the present disclosure.

The server apparatus 10 may include a wallet management unit 101, an on-chain information acquisition unit 102, an off-chain information acquisition unit 103, and a display information output unit 104.

The wallet management unit 101 has a function of managing the wallet. Specifically, the wallet management unit 101 may store information for connecting to the wallet of the user. The on-chain information acquisition unit 102 has a function of acquiring information about the content recorded in the distributed ledger network.

The off-chain information acquisition unit 103 has a function of acquiring information about the content stored in the server apparatus. The display information output unit 104 has a function of outputting information for displaying on-chain information and off-chain information of content designated from the user (hereinafter, referred to as designated content) on one content moving screen.

### Program Execution Processing

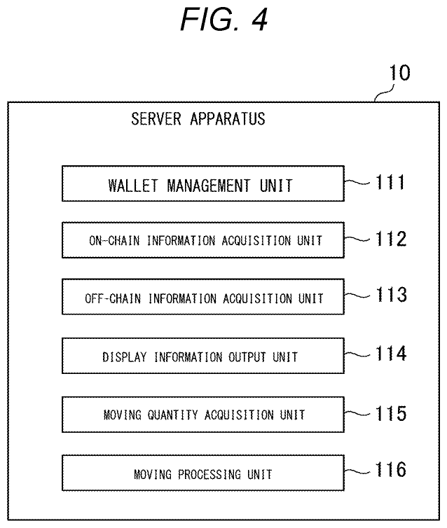

Next, program execution processing in the first embodiment of the present disclosure will be described. FIG. 3 is a flowchart of the program execution processing according to at least one embodiment of the present disclosure.

The server apparatus 10 acquires the information about the content recorded in the distributed ledger network (step S1). Next, the server apparatus 10 acquires the information about the content stored in the server apparatus (step S2).

Next, the server apparatus 10 outputs the information for displaying the on-chain information and the off-chain information of the designated content on one content moving screen (step S3) and finishes the processing.

As one aspect of the first embodiment, a new system that enables a user to easily perceive states of off-chain and on-chain content can be provided.

In the first embodiment, the term “terminal apparatus” refers to, for example, a stationary game console, a portable game console, a wearable terminal, a desktop or laptop personal computer, a tablet computer, or a PDA and may be a portable terminal such as a smartphone including a touch panel sensor on a display screen. The term “server apparatus” refers to, for example, an apparatus that executes processing in accordance with a request from the terminal apparatus. The term “content” is, for example, digital content that can be used in the service and, more specifically, refers to an NFT art, a character, an enemy object, an object that can be disposed in a virtual space, an item that can be used by the character, and the like.

The term “on-chain” refers to, for example, a transaction recorded in the distributed ledger network and indicates that information recorded in the distributed ledger network is used. The term “off-chain” refers to, for example, a transaction made in an environment outside the distributed ledger network and indicates that information processed or stored in the server apparatus is used.

The term “content moving screen” refers to, for example, a screen for moving the information stored in the server apparatus and the information recorded in the distributed ledger network. That is, the content moving screen refers to a screen for displaying information present in different environments on one screen so that positions at which the information is present can be changed.

### Second Embodiment

A summary of a second embodiment of the present disclosure will be described. Hereinafter, a system that includes a terminal apparatus and a server apparatus connected to the terminal apparatus through a communication network and that provides a service including one or more pieces of content will be illustratively described as the second embodiment.

### Summary of System

In the second embodiment of the present disclosure, a game will be described as an example of the service. In addition, digital content that can be used in the game will be described as an example of the content. More specifically, an NFT art, a character, an enemy object, an object that can be disposed in a space in the game, an item that can be used by the character, and the like will be described.

The content may include content for which an NFT corresponding to the content can be issued and content for which the NFT cannot be issued. While the content described below is limited to the content for which the NFT can be issued, the content for which the NFT cannot be issued may be included.

As an assumption for the service in the second embodiment, it may be determined that the user is in a state where the user can make transactions of the NFT in advance. For example, the game may start on a condition that the user has an account with the distributed ledger network.

A configuration of the system, the server apparatus 10, the communication network 20, the terminal apparatus 30, and the distributed ledger network 40 in the second embodiment can employ the system, the server apparatus 10, the communication network 20, the terminal apparatus 30, and the distributed ledger network 40 described in the first embodiment and the contents described in FIG. 1, as necessary.

### Description of Functions

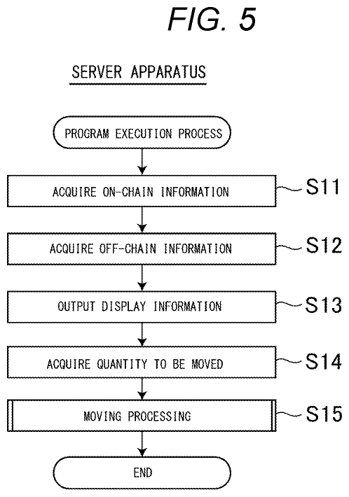

Functions of the server apparatus 10 in the second embodiment will be described. FIG. 4 is a block diagram illustrating a configuration of the server apparatus according to at least one embodiment of the present disclosure.

The server apparatus 10 may include a wallet management unit 111, an on-chain information acquisition unit 112, an off-chain information acquisition unit 113, a display information output unit 114, a moving quantity acquisition unit 115, and a moving processing unit 116.

The wallet management unit 111 has a function of managing the wallet. Specifically, the wallet management unit 111 may store information for connecting to the wallet of the user. The on-chain information acquisition unit 112 has a function of acquiring information about the content recorded in the distributed ledger network.

The off-chain information acquisition unit 113 has a function of acquiring information about the content stored in the server apparatus. The display information output unit 114 has a function of outputting information for displaying on-chain information and off-chain information of content designated from the user (hereinafter, referred to as designated content) on one content moving screen.

The moving quantity acquisition unit 115 has a function of acquiring a quantity of pieces of the designated content to be moved received by the terminal apparatus 30. The moving processing unit 116 has a function of moving the pieces of the designated content of the quantity acquired by the moving quantity acquisition unit 115 to the distributed ledger network or to the server apparatus.

### Program Execution Processing

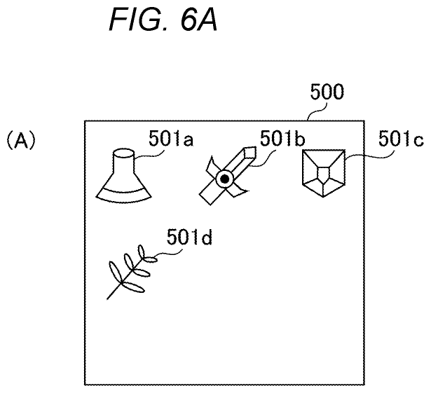

Next, program execution processing in the second embodiment of the present disclosure will be described. FIG. 5 is a flowchart of the program execution processing according to at least one embodiment of the present disclosure.

The server apparatus 10 acquires the information about the content recorded in the distributed ledger network (step S11). Wallet information of the user managed by the wallet management unit 111 is used for connecting to the distributed ledger network. Next, the server apparatus 10 acquires the information about the content stored in the server apparatus (step S12).

Next, the server apparatus 10 outputs the information for displaying the on-chain information and the off-chain information of the designated content on one content moving screen (step S13).

The terminal apparatus 30 receives the output information and displays the content moving screen. Data constituting the content moving screen may be stored in advance in the terminal apparatus 30.

### Content Moving Screen

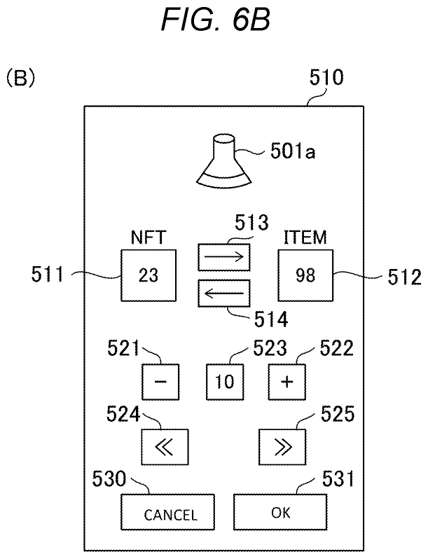

FIGS. 6A and 6B are diagrams for illustrating selection of the content and the content moving screen according to at least one embodiment of the present disclosure. FIG. 6A is a diagram illustrating a list of content owned by the user in the service.

A content list screen 500 displays, for example, content 501a, 501b, 501c, and 501d owned by the user. Information about content 501 displayed on the content list screen 500 may be acquired from the server apparatus 10 and from the distributed ledger network 40, or the server apparatus 10 may store information for managing the content owned by the user.

FIG. 6B is a diagram illustrating the content moving screen. Here, it is assumed that the user has selected the content 501a on the content list screen 500. A content moving screen 510 displays, for example, the selected content 501a, a quantity 511 of pieces of the content 501a managed in the distributed ledger network 40, a quantity 512 of the content 501amanaged in the server apparatus 10, a change instruction button 513 for the quantity from the distributed ledger network 40 to the server apparatus 10, a change instruction button 514 for the quantity from the server apparatus 10 to the distributed ledger network 40, a decrease button 521 for decreasing a unit quantity to be changed, an increase button 522 for increasing the unit quantity to be changed, a unit quantity to be changed 523, a button 524 for moving all of the quantity 512 of pieces of the content 501a managed in the server apparatus 10 to the distributed ledger network 40, a button 525 for moving all of the quantity 511 of pieces of the content 501a managed in the distributed ledger network 40 to the server apparatus 10, a cancel button 530 for closing the content moving screen 510 without performing moving processing, and a confirm button 531 for executing the moving processing.

In a case where the change instruction buttons 513 and 514 are pressed, the quantity 511 or the quantity 512 is changed by a quantity corresponding to the unit quantity to be changed 523. The change of the quantity is not confirmed unless the confirm button 531 is pressed.

By displaying the quantity managed in the server apparatus 10 and the quantity managed in the distributed ledger network 40 on one screen like the content moving screen 510, the user can easily perceive states of off-chain and on-chain content.

The content moving screen 510 may display the quantity managed in the server apparatus 10 and the quantity managed in the distributed ledger network 40 on one screen, and information may be disposed to be comparable by the user. That is, the quantity 511 and the quantity 512 may be disposed on the left and the right of each other as illustrated in FIG. 6B, may be disposed above and below each other, or may be disposed in other manners. In addition, while the quantities 511 and 512 are displayed as numerical values, only the number of pieces of the content 501a that are present, for example, may be displayed as an image such as an icon indicating the quantity, and the image may be selected and moved. Moving may be performed by dragging using an input device such as a mouse, or in a case where a touch panel is used, the content may be tapped and then slid to be moved.

The flowchart in FIG. 5 will be referred to again. The server apparatus 10 acquires the quantity of pieces of the designated content to be moved received by the terminal apparatus 30 through an operation of the user (step S14). In a case where the quantity to be moved is determined and then the confirm button 531 is pressed on the content moving screen 510, the terminal apparatus 30 receives the quantity to be changed.

Next, the server apparatus 10 moves the pieces of the designated content of the quantity acquired in step S14 to the distributed ledger network or to the server apparatus (step S15) and finishes the processing.

### Moving Processing

Moving of the content is divided into moving from the server apparatus 10 to the distributed ledger network 40 and moving from the distributed ledger network 40 to the server apparatus 10.

First, moving from the server apparatus 10 to the distributed ledger network 40 will be described. In the case of recording the content stored in the server apparatus 10 in the distributed ledger network 40, a non fungible token (hereinafter, referred to as an NFT) is issued for the quantity of pieces of the content to be moved. At this point, an indication that an owner is the user is recorded in the nodes included in the distributed ledger network 40. In addition, the same number of pieces of the designated content are deleted from the storage device of the server apparatus 10.

Next, moving from the distributed ledger network 40 to the server apparatus 10 will be described. In the case of storing the content recorded in the distributed ledger network 40 in the server apparatus 10, the quantity to be moved is stored in the server apparatus 10. In addition, the same number of NFTs related to the designated content are deleted from the distributed ledger of the distributed ledger network 40.

While there is a method such as adding a token by designating a contract address for moving the content, the method deviates from the gist of the present disclosure disclosed herein and thus, will not be described.

In the second embodiment, the content may be purchased using virtual currency owned by the user. The purchased content may be provided on-chain to the wallet as an NFT. The user may be able to use the purchased content in the service by moving the purchased content to the server apparatus from the NFT.

As one aspect of the second embodiment, a new system that enables a user to easily perceive states of off-chain and on-chain content can be provided.

As one aspect of the second embodiment, by displaying the quantity to be moved in an aspect in which the quantity to be moved can be increased and decreased in predetermined units that can be set by the user, usability of the service can be improved.

As one aspect of the second embodiment, by displaying the quantity of pieces of the content acquired by the on-chain information acquisition unit 112 or by the off-chain information acquisition unit 113 in an aspect in which the quantity of pieces of the content can be designated through a one-time operation, the usability of the service can be improved.

In the second embodiment, each of the terms “terminal apparatus”, “server apparatus”, “content”, “on-chain”, “off-chain”, and “content moving screen” can employ the contents described in the first embodiment, as necessary.

In the disclosure, the functions of the system 1 may be implemented by, for example, sharing the functions among the server apparatus 10, the terminal apparatus 30, and the distributed ledger network 40.

In the disclosure, any of the server apparatus 10 and the terminal apparatus 30 may be the node 45 of the distributed ledger network 40.

The contents described in each of the embodiments may be appropriately combined with each other to be designed by those skilled in the art.

### Appendix

The above description of the embodiments has been provided to enable those having ordinary knowledge in the field of the present disclosure to embody the following present disclosure.

[1] A program to be executed in a server apparatus in a system that includes a terminal apparatus and the server apparatus connected to the terminal apparatus through a communication network and that provides a service including one or more pieces of content, wherein
the terminal apparatus and/or the server apparatus are/is capable of communicating with a distributed ledger network,
ownership of the content is recordable in the distributed ledger network, and furthermore,
the content is stored in a storage device of the server apparatus or recorded on a distributed ledger included in the distributed ledger network, and the program causes the server apparatus to implement:
   an on-chain information acquisition unit that acquires information about the content recorded in the distributed ledger network;
   an off-chain information acquisition unit that acquires information about the content stored in the server apparatus; and
   a display information output unit that outputs information for displaying on-chain information and off-chain information of content designated from a user (hereinafter, referred to as designated content) on a content moving screen.

[2] The program according to [1], further causing the server apparatus to implement:
a moving quantity acquisition unit that acquires a quantity of pieces of the designated content to be moved, the quantity of pieces received by the terminal apparatus; and
a moving processing unit that:
   in a case of moving the designated content from the server apparatus to the distributed ledger network, issues a non-fungible token (hereinafter, referred to as an NFT) for the acquired quantity of pieces of the content to be moved and deletes the quantity of pieces of the designated content from the storage device of the server apparatus; and/or
   in a case of moving the designated content from the distributed ledger network to the server apparatus, deletes the NFTs of the acquired quantity of pieces of the content to be moved and registers the quantity of pieces of the designated content in the storage device of the server apparatus.

[3] The program according to [1] or [2], wherein the display information output unit outputs the information for displaying the quantity to be moved in an aspect in which the quantity to be moved is increasable or decreasable in predetermined units settable by the user.

[4] The program according to [1] or [2], wherein the display information output unit outputs the information for displaying the information about the content acquired by the on-chain information acquisition unit or by the off-chain information acquisition unit in an aspect in which the information about the content is designatable through a one-time operation.

[5] A server apparatus on which the program according to [1] is installed.

[6] A system that includes a terminal apparatus and a server apparatus connected to the terminal apparatus through a communication network and that provides a service including one or more pieces of content, wherein
the terminal apparatus and/or the server apparatus are/is capable of communicating with a distributed ledger network,
ownership of the content is recordable in the distributed ledger network, and furthermore,
the content is stored in a storage device of the server apparatus or recorded on a distributed ledger included in the distributed ledger network, and
the system includes:
   an on-chain information acquisition unit that acquires information about the content recorded in the distributed ledger network;
   an off-chain information acquisition unit that acquires information about the content stored in the server apparatus; and
   a display unit that displays on-chain information and off-chain information of content designated from a user (hereinafter, referred to as designated content) on a content moving screen on the terminal apparatus.

[7] A program to be executed in a terminal apparatus in a system that includes the terminal apparatus and a server apparatus connected to the terminal apparatus through a communication network and that provides a service including one or more pieces of content, wherein
the terminal apparatus and/or the server apparatus are/is capable of communicating with a distributed ledger network,
ownership of the content is recordable in the distributed ledger network, and furthermore,
the content is stored in a storage device of the server apparatus or recorded on a distributed ledger included in the distributed ledger network, and
the program causes the terminal apparatus to implement:
   an on-chain information acquisition unit that acquires information about the content recorded in the distributed ledger network;
   an off-chain information acquisition unit that acquires information about the content stored in the server apparatus; and
   a display unit that displays on-chain information and off-chain information of content designated from a user (hereinafter, referred to as designated content) on a content moving screen.

[8] A terminal apparatus on which the program according to [7] is installed.

[9] A control method to be executed in a server apparatus in a system that includes a terminal apparatus and the server apparatus connected to the terminal apparatus through a communication network and that provides a service including one or more pieces of content, wherein
the terminal apparatus and/or the server apparatus are/is capable of communicating with a distributed ledger network,
ownership of the content is recordable in the distributed ledger network, and furthermore,
the content is stored in a storage device of the server apparatus or recorded on a distributed ledger included in the distributed ledger network, and
the control method includes:
   a step of acquiring information about the content recorded in the distributed ledger network;
   a step of acquiring information about the content stored in the server apparatus; and
   a step of outputting information for displaying on-chain information and off-chain information of content designated from a user (hereinafter, referred to as designated content) on a content moving screen.

[10] A control method to be executed in a system that includes a terminal apparatus and a server apparatus connected to the terminal apparatus through a communication network and that provides a service including one or more pieces of content, wherein
the terminal apparatus and/or the server apparatus are/is capable of communicating with a distributed ledger network,
ownership of the content is recordable in the distributed ledger network, and furthermore,
the content is stored in a storage device of the server apparatus or recorded on a distributed ledger included in the distributed ledger network, and
the control method includes:
   a step of acquiring information about the content recorded in the distributed ledger network;
   a step of acquiring information about the content stored in the server apparatus; and
   a step of displaying on-chain information and off-chain information of content designated from a user (hereinafter, referred to as designated content) on a content moving screen on the terminal apparatus.

At least one of the embodiments of the present disclosure is effective as a program, a system, and a control method that enable a user to easily perceive states of off-chain and on-chain content.

What is claimed is:

1. A non-transitory computer-readable recording medium having recorded thereon a program to be executed in a server apparatus in a system that includes a terminal apparatus and the server apparatus connected to the terminal apparatus through a communication network and that provides a service including one or more pieces of content, wherein
the terminal apparatus and/or the server apparatus are/is capable of communicating with a distributed ledger network,
ownership of the content is recordable in the distributed ledger network,
the content is stored in a storage device of the server apparatus or recorded on a distributed ledger included in the distributed ledger network, and
the program, when executed, causes the server apparatus to perform:
acquiring information about the content recorded on the distributed ledger in the distributed ledger network;
acquiring information about the content stored in the storage device of the server apparatus; and
outputting information for displaying on-chain information and off-chain information of the content designated from a user on a content moving screen.

2. The non-transitory computer-readable recording medium according to claim 1, wherein the program, when executed, further causes the server apparatus to perform:
acquiring a quantity of pieces of the designated content to be moved, the quantity of pieces received by the terminal apparatus, and
moving processing that
issues a non-fungible token (NFT) for the acquired quantity of pieces of the designated content to be moved and deletes the acquired quantity of pieces of the designated content from the storage device of the server apparatus, in a case of moving the designated content from the server apparatus to the distributed ledger network, and/or
deletes the NFT of the acquired quantity of pieces of the designated content to be moved and registers the acquired quantity of pieces of the designated content in the storage device of the server apparatus, in a case of moving the designated content from the distributed ledger network to the server apparatus.

3. The non-transitory computer-readable recording medium according to claim 1, wherein the program, when executed, further causes the server apparatus to perform outputting information for displaying a quantity of pieces of the designated content to be moved such that the quantity is increasable or decreasable in one or more predetermined units settable by the user.

4. The non-transitory computer-readable recording medium according to claim 1, wherein the program, when executed, further causes the server apparatus to perform outputting information for displaying the acquired information about the content such that the acquired information is designatable through a one-time operation.

5. A server apparatus on which the program recorded on the non-transitory computer-readable recording medium according to claim 1 is installed.

6. A system that includes a terminal apparatus and a server apparatus connected to the terminal apparatus through a communication network and that provides a service including one or more pieces of content, wherein
the terminal apparatus and/or the server apparatus are/or capable of communicating with a distributed ledger network,
ownership of the content is recordable in the distributed ledger network,
the content is stored in a storage device of the server apparatus or recorded on a distributed ledger included in the distributed ledger network, and
the system is configured to:
acquire information about the content recorded on the distributed ledger in the distributed ledger network;
acquire information about the content stored in the storage device of the server apparatus; and
display on-chain information and off-chain information of the content designated from a user on a content moving screen on the terminal apparatus.

7. A control method to be executed in a system that includes a terminal apparatus and a server apparatus connected to the terminal apparatus through a communication network and that provides a service including one or more pieces of content, wherein
the terminal apparatus and/or the server apparatus are/is capable of communicating with a distributed ledger network,
ownership of the content is recordable in the distributed ledger network,
the content is stored in a storage device of the server apparatus or recorded on a distributed ledger included in the distributed ledger network, and
the control method comprises:
acquiring information about the content recorded on the distributed ledger in the distributed ledger network,
acquiring information about the content stored in the storage device of the server apparatus, and
displaying on-chain information and off-chain information of the content designated from a user on a content moving screen on the terminal apparatus.

8. The non-transitory computer-readable recording medium according to claim 2, wherein the program, when executed, further causes the server apparatus to perform outputting information for displaying the quantity of pieces of the designated content to be moved such that the quantity is increasable or decreasable in one or more predetermined units settable by the user.

9. The non-transitory computer-readable recording medium according to claim 2, wherein the program, when executed, further causes the server apparatus to perform outputting information for displaying the acquired information about the content such that the acquired information is designatable through a one-time operation.
